(19) United States
(12) Patent Application Publication
(10) Pub. No.: US 2022/0044144 A1
(43) Pub. Date: Feb. 10, 2022

(54) REAL TIME MODEL CASCADES AND DERIVED FEATURE HIERARCHY

(71) Applicant: INTUIT INC., Mountain View, CA (US)

(72) Inventors: Frank WISNIEWSKI, San Francisco, CA (US); Abhishek JAIN, Mountain View, CA (US); Caio Vinicius SOARES, Redwood City, CA (US); Joseph Brian CESSNA, San Diego, CA (US); Tristan Cooper BAKER, San Diego, CA (US); WeiFeng ZHANG, San Jose, CA (US)

(21) Appl. No.: 16/986,022

(22) Filed: Aug. 5, 2020

(51) Int. Cl. G06N 20/00; G06K 9/62; G06F 9/30

(52) U.S. Cl. CPC G06N 20/00; G06K 9/6256; G06F 9/30036; G06K 9/623

(57) ABSTRACT

Certain aspects of the present disclosure provide techniques for a feature management platform to asynchronously implement an ensemble of machine learning models (or AI/ML models). The feature management platform can transmit feature data presently available on the feature queue (e.g., published on the feature queue or retrieved from a persistent data layer). The feature management platform can transmit the feature data to a first group of the machine learning models, capable of inputting the presently available feature data to generate predictions. The predictions can be transmitted back to the feature queue to consume—as well as store in the persistent data layer. The predictions, as well as any newly generated feature data, can be provided to the remaining machine learning models in the ensemble. The prediction of the ensemble can then provided to a consumer (e.g., an organization).

### INTRODUCTION

Aspects of the present disclosure relate to the operation of a feature management platform configured to manage the full lifecycle of feature data.

### BACKGROUND

Within the field of data science and analytics, artificial intelligence and machine learning are rapidly growing. More and more entities and organizations are adopting and implementing such technologies. As the field (and popularity) of artificial intelligence and machine learning grows and further develops, so too does the technology for supporting artificial intelligence and machine learning. One such technology focuses on data processing. Generally, large amounts of feature data are needed to train artificial intelligence and machine learning models. Such data can be used both to train models and to generate predictions (or “inferences”) for specific use cases based on the trained models.

In order to implement data processing at the scale and level feasible for artificial intelligence and machine learning models, a significant amount of resources is often devoted to the collection, transformation, and storage of data. Not only that, the time and costs associated with developing data processing techniques for artificial intelligence and machine learning models can be high. There is also the risk of generating duplicate feature data when implementing data processing techniques, resulting in more resources being consumed than necessary. Further, there is also a dependence on data engineers when attempting to manage the full lifecycle of feature data. In such instances, the dependence on data engineers also increases the time with which it takes to provide useful feature data.

Additionally, conventional methods of data processing are time-intensive and often lack the latest feature data, preventing timely generation of predictions by artificial intelligence and machine learning models, such as for fraud detection, user support, and so forth. As a result, organizations and entities implementing artificial intelligence and machine learning models may base decisions on low quality predictions (e.g., predictions based on old feature data).

Conventional methods attempt to address the shortcomings (as described above) of data processing of feature data. However, conventional methods are often standalone, ad hoc solutions that lack the governance, model integration, and flexibility to create feature data for streaming (or real-time) and batch aggregations. Additional limitations of conventional methods include a lack of reusability and shareability of the feature data as well as the failure of the conventional methods to manage the entire lifecycle of feature data in a reliable, scalable, resilient, and easily useable manner.

As such, a solution is needed that can overcome the shortcomings of the conventional methods to manage the complete lifecycle of feature data in a scalable and reusable manner.

### BRIEF SUMMARY

Certain embodiments provide a method for a feature management platform that operates to manage feature data. The method generally includes generating a first set of features from one or more data sources. The method further includes publishing the first set features as a feature vector in a feature queue of a feature management platform. The method further includes transmitting the feature vector from the feature queue to a first machine learning model. The method further includes receiving a prediction generated by the first machine learning model. The method further includes transmitting the prediction to a second machine learning model.

Certain embodiments provide a method for a machine learning model interacting with a feature management platform. The method generally includes monitoring a feature queue of a feature management platform for a new feature. The method further includes retrieving the new feature from the feature management platform. The method further includes inputting the new feature to a machine learning model. The method further includes generating a prediction based on the new feature. The method further includes transmitting the prediction to the feature management platform.

Other embodiments provide systems for a feature management platform that interacts with machine learning model(s) and operates to manage feature data and/or predictions (e.g., receive predictions, provide feature data and/or predictions). Additionally, other embodiments provide non-transitory computer-readable storage mediums comprising instructions for a feature management platform that interacts with machine learning model(s) and operates to manage feature data and/or predictions (e.g., receive predictions, provide feature data and/or predictions).

The following description and the related drawings set forth detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example feature management platform, according to an embodiment.

FIG. 2 depicts example diagram of the feature management platform interacting with models, according to an embodiment.

FIG. 3 depicts an example pipeline of the feature management platform, according to an embodiment.

FIG. 4 depicts an example flow diagram of the feature management platform interactions with models hosted on computing device(s), according to an embodiment.

FIG. 5 depicts an example flow diagram of a model hosted on a computing device interacting with a feature management platform, according to an embodiment.

FIG. 6 depicts an example server for the feature management platform, according to an embodiment.

FIG. 7 depicts an example computing device, according to an embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and non-transitory computer readable mediums for the operation of a feature management platform, which is an end-to-end platform for managing the full lifecycle of feature data (e.g., discovery, creation, use, governing, and deployment of feature data).

Organizations and entities that depend on feature data processing for artificial intelligence and/or machine learning (AI/ML) models can implement and/or utilize a feature management platform. Due to the pluggability and multi-tenancy nature of the feature management platform, multiple types of computing devices (or machine learning models) can connect to (or “plug” into) the feature management platform for discovering, creating, sharing, re-using, etc., feature data, including stateful and stateless features. Such data is used for training and implementing use cases of models on computing devices. Further, the feature management platform can interact with computing devices and/or models to receive and distribute generated predictions.

Generally, feature data can include event data that is featurized, such as geographic lookups (e.g., based on IP addresses, zip codes, and other types of geographic identifying data), counts of user activity (e.g., clicks on a link, visits to a web site, and other types of countable user activity), and other types of featurized data based on event data collected by an organization. The event data can include raw data gathered through interactions and operations of the organization. For example, an organization that provides user support of products and/or services offered by that organization can collect information (e.g., event data) such as IP addresses of users accessing online user support, number of times a user contacts user support (e.g., via phone, email, etc.), and so forth. Such event data can be featurized to generate feature data, which can include stateful features and stateless features, by the feature management platform. For example, stateful features can be calculated using aggregation operations over a period of time (e.g., count, count distinct, sum, min, max, etc.). Stateless features can be the last value (or latest in time value) of a feature (e.g., a last IP address of a user).

The feature data can be retrieved (e.g., via computing devices) from the feature management platform to train and implement models to generate predictions (or inferences) that can assist the organization in making operational decisions. Further, the feature management platform can interact with models hosted on computing devices to receive and distribute predictions generated to other models and/or computing devices, which in turn can reduce the consumption of resources by an organization including computing resources, time, money, etc.

The feature management platform provides the tooling and framework for managing data transformations, which in turn allows for creation of feature data for AL/ML models. The feature management platform includes components that enable the sharing and reusability of feature data (e.g., stateful and stateless features) to other models as well as reducing data corruption and data duplication. Further, the feature management platform can automate aspects of data processing such that dependence on data engineers is reduced.

As part of managing the full lifecycle of feature data, an organization can utilize the feature management platform to asynchronously implement an ensemble of machine learning models (or AI/ML models). In an embodiment, an organization can utilize the feature management platform to manage user interactions (e.g., of customers, employees, etc.) with the organization. For example, the feature management platform can manage operations associated with the organization, such as user login and/or access to resources associated with the organization.

In one example, the organization can ensure via the feature management platform that the user is who they claim to be (e.g., at login) by implementing an ensemble of machine learning models that can accurately determine and/or confirm user identity as well as alert the organization to a fraudulent user. In another example, the organization can ensure via the feature management platform that a user receives the proper assistance (e.g., user support) as needed. The feature management platform can also assist an organization in determining product and/or service abandonment via an ensemble of machine learning models that are connected to the feature management platform and generating predictions (e.g., of abandonment of a product and/or service) based on input data (e.g., feature data and/or predictions) provided to the machine learning models.

Rather than implementing an ensemble of machine learning models at the same time, which can result in inaccurate determinations and/or confirmations of user identity (e.g., due to missing or outdated input data), the feature management platform can asynchronously implement the ensemble of machine learning models.

For example, an ensemble of machine learning models can be subscribers to one or more channels of a feature queue in the feature management platform. Upon feature data being stored in the feature queue (e.g., from the feature processing component, from a prediction received from a machine learning model, etc.), the machine learning model that is subscribed to a channel can retrieve (or receive) the feature data from the feature management platform. In doing so, a first group of machine learning models that have available input data stored in the feature queue can retrieve the available input data. By providing feature data upon availability to subscribing machine learning models, the feature management platform can trigger execution of the respective machine learning models at a first time with each other but also asynchronously with respect to the other models of the ensemble that are provided feature data from the feature management platform at a later time.

In some cases, the available input data can be at a feature queue of the feature management platform from which the first group of machine learning models can retrieve the available input data. In other cases, the available input data can be stored in a fast retrieval database or a training data database. The available input data can be retrieved by the feature queue from the fast retrieval database or a training data database and stored on a channel in the feature queue to transmit to one or more machine learning models that are subscribers to the channel in the feature queue (e.g., via a subscription service). A machine learning model can also directly retrieve available input data from the fast retrieval database or a training data database (e.g., based on a request made via the host computing device to the feature management platform).

After transmitting the available input data to the first group of machine learning models, the feature management platform can receive the predictions generated by the first group of machine learning models. The predictions can be of regression type, classification type, etc., based on the underlying models. In some cases, the feature management platform can receive the predictions at different times. In other cases, the feature management platform can generate new feature data based on availability of event data after sending input data to the first group of models. The feature management platform can then transmit (e.g., at different times) the received predictions and/or newly generated feature data to the other machine learning models of the ensemble. In some cases, the feature management platform can also send the newly available feature data to the first group of models to continue generating updated predictions. By transmitting the feature data and/or predictions as they become available to subscribing machine learning models, the other machine learning models can be asynchronously implemented—not only with each other but also the first group of machine learning models in the ensemble of machine learning models.

By asynchronously implementing the ensemble of machine learning models, the feature management platform can ensure more accurate predictions generated by the models. With more accurate predictions, an organization that uses the feature management platform to implement and manage an ensemble of machine learning models can prevent inaccurate results from being generated and negatively impacting the organization.

For example, the feature management platform can timely and accurately prevent unconfirmed users from accessing privileged or confidential information via the ensemble of machine learning models that are implemented asynchronously with the latest available data. Further, the feature management platform can properly and timely assist a user interacting with the organization (e.g., via a software program product) based on an ensemble of machine learning models implemented to generate a prediction of user activity. For example, the ensemble of machine learning models connected to the feature management platform can determine if the user is having difficulty with an aspect of the software program product, and then accordingly provide assistance. Additionally, the ensemble of machine learning models connected to the feature management platform can generate a prediction as to whether a user is going to continue using or abandon a product and/or service provided by the organization.

Further, such a feature management platform capable of managing the full life cycle of feature data also minimizes dependency on data engineering, which can be resource intensive and costly. Additionally, the feature management platform reduces the time for creation, modification, deployment, and use of features because the feature management platform is a consolidated platform of components that can manage the entire lifecycle of feature data. Through automation of data processing as well as components of the feature management platform (e.g., feature registry, feature queue, etc.), the feature management platform can allow a plurality of different types of computing devices and/or models to connect to, access, and interact with the feature management platform. Further, with the connection to the feature management platform, the computing devices and/or models can discover, create, implement, share, re-use, etc., feature data without the risk of feature data duplication and expending unnecessary resources. For example, without the feature management platform, data engineers may generate non-real time feature data, including duplicate instances of feature data, which would not be reusable.

### Example Feature Management Platform

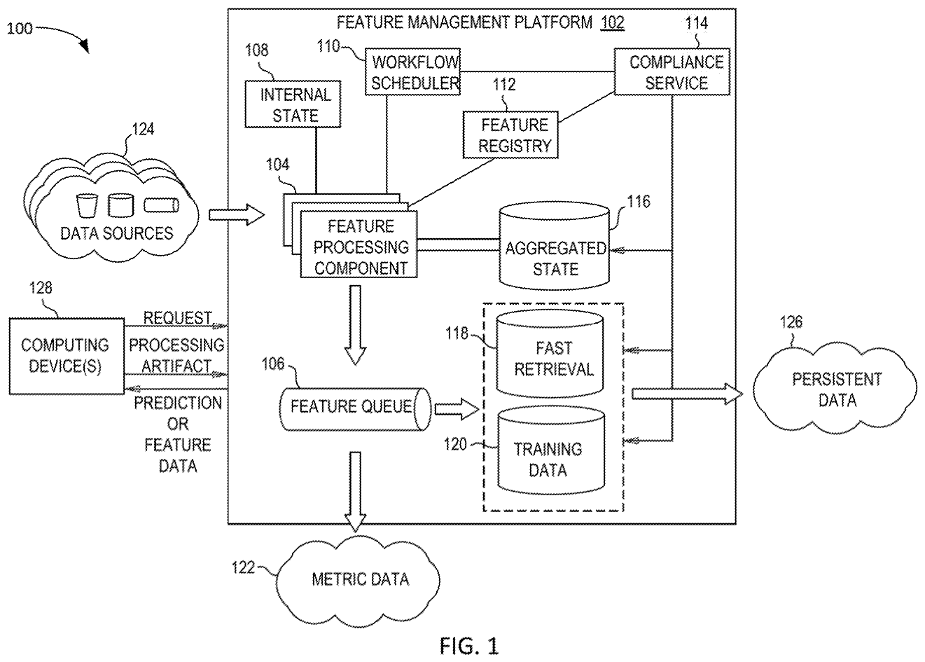

FIG. 1 depicts an example framework 100 of a feature management platform 102. The feature management platform 102 is a processing framework that supports the complete lifecycle management of feature data, including stateful and stateless features. For example, the feature management platform 102 supports the creation, discovery, shareability, re-usability, etc. of feature data among a plurality of computing devices and/or models that connect to the feature management platform 102.

In one embodiment, the processing framework of the feature management platform 102 supports feature calculations (including stateful feature and stateless feature calculations), a feature queue, and various attached storages.

The feature management platform 102 includes (or is associated with) a set of components. For example, one or more components of the feature management platform 102 can be components that democratize (or e.g., make accessible) the feature management platform 102 infrastructure. Other components of the set of components of the feature management platform 102 “face” or interact directly with computing devices and/or models. Some components of the feature management platform 102 can be shared components, external services, data sources, or integration points. Due to the integration of all of the components, the feature management platform 102 is able to provide feature data (e.g., stateful or stateless features) to computing devices and/or AWL models hosted thereon and manage the full lifecycle of feature data (e.g., discovery, creation, use, deployment, etc.).

In some cases, a distributed system can implement the feature management platform 102, such that the components of the feature management platform 102 can be located at different network computing devices (e.g., servers).

In one embodiment, the feature management platform 102 can include feature processing component 104, a feature queue 106, an internal state 108, a workflow scheduler 110, a feature registry 112, a compliance service 114, an aggregated state 116, a fast retrieval database 118, a training data database 120, metric data 122, data sources 124, and persistent data 126.

The feature management platform 102 can interact with a plurality of computing devices 128 and machine learning models. A computing device 128 can host one or more machine learning models. Due to the multi-tenancy of the feature management platform 102, multiple computing devices 128 and/or machine learning models can connect to, access, and use the feature management platform 102. In some cases, a computing device 128 can submit requests for feature data and/or prediction(s). In other cases, a computing device 128 can provide processing artifacts (e.g., a configuration file and/or code fragments). In other cases, the computing device 128 can retrieve feature data and/or predictions from feature management platform 102.

For example, the computing device 128 can retrieve a prediction stored by the feature management platform 102 that was generated by another computing device that locally hosts a trained model. In another example, the computing device 128 can retrieve feature data from the feature management platform 102 as a feature vector message. Computing devices 128 can include a computer, laptop, tablet, smartphone, a virtual machine, container, or other computing device with the same or similar capabilities (e.g., that includes training and implementing models, serving predictions to applications running on such computing device, and interacting with the feature management platform).

The feature processing component 104 of the feature management platform 102 can include an API for implementing data transformations on event data (e.g., streaming or batch data) in order to generate feature data (or feature values) including stateful features and stateless features. Event data can include raw data from data sources associated with the feature management platform 102. For example, in the context of an organization that provides service(s) and/or product(s), the raw data can include user information (e.g., identifiers), IP addresses, counts of user action (e.g., clicks, log in attempts, etc.), timestamps, geolocation, transaction amounts, and other types of data collected by the organization.

In some cases, the feature management platform 102 can receive a processing artifact from a computing device 128. For example, the computing device 128 can be associated with an organization that is associated with (and can connect to) the feature management platform 102. Based on the processing artifact, the feature processing component 104 can generate and initiate a processing job that generates feature data.

The processing artifact can include a definition of the feature, including what data sources 124 to retrieve event data from, what transform(s) to apply to the event data, how far back and/or how long to retrieve event data, where to provide the feature vectors, etc. In such cases, the feature processing component 104 can retrieve event data from a data source 124 and apply one or more transformations to the event data to generate feature data, based on the feature defined in the processing artifact.

The data sources 124 can include sources of batch and streaming data that connect to the feature management platform 102. In some cases, the event data from data sources 124 can be either streaming data or batch data collected by the organization(s) associated with the feature management platform 102. In order for the feature processing component 104 of the feature management platform 102 to transform event data into feature data or values (e.g., in a feature vector), event data can be retrieved from data sources 124 that are exposed (or connected via, e.g., APACHE SPARK™) to the feature management platform 102. For example, the event data can be retrieved via the API of the feature processing component 104. In some cases, the data sources 124 can include KAFKA® topics (e.g., for streaming data). In other cases, the data sources 124 can include Hive tables or S3 buckets (e.g., for batch data).

The feature processing component 104 of the feature management platform 102 can be supported by analytics engines (e.g., APACHE SPARK™) capable of data transformation of both streaming and batch data (e.g., APACHE KAFKA® topic(s), APACHE HIVE™ tables, AMAZON® S3 buckets). The feature processing component 104 can implement transforms by leveraging the API. In some cases, the API can be built on top of APACHE SPARK™. The API of the feature processing component 104 can support, for example, Scala, SQL, and Python as interface languages as well as other types of interface languages compatible with the API.

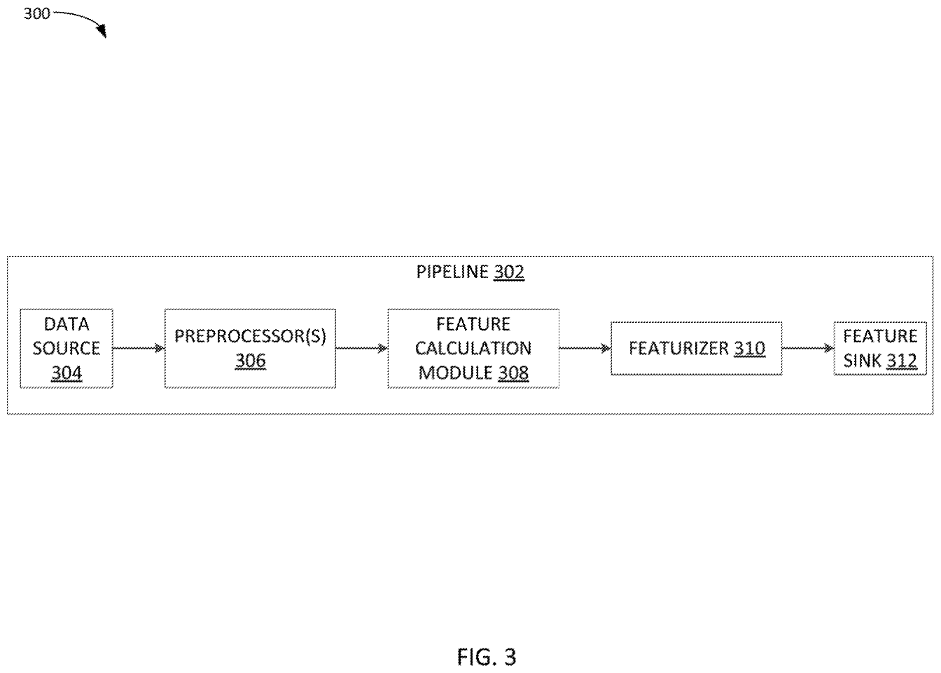

One aspect of the feature processing component 104 includes a pipeline (as described in FIG. 3) that provides the feature processing component 104 of the feature management platform 102 the ability to process event data in either streaming or batch mode to generate feature data. Further, based on the pipeline, the feature processing component 104 component can backfill feature values and allow users of the feature management platform 102 to control the featurization logic and aggregation logic (e.g., by accepting processing artifacts from computing devices). In some cases, the feature processing component 104 can include a pipeline for each computing device 128 connected to the feature management platform 102 as part of multi-tenancy support of the feature management platform 102, providing access and service to more than one computing device 128.

Upon the feature processing component 104 generating and initiating a processing job, the resulting output of the feature processing component 104 is a set of feature values (e.g., feature data). In some cases, the feature data may be encapsulated as a vector (or a set of feature vectors or tensors) and published on a feature queue 106.

For example, upon determining the latest in time value of a feature (e.g., the stateless feature), the feature value can be encapsulated as a vector. In other cases, the feature data (e.g., a stateful feature) can be generated based on the feature values. For example, the feature values can be stored in an aggregated state 116 (e.g., a cache external to the feature processing component 104) and retrieved by the feature processing component 104 when an aggregation time window is complete. Upon retrieving the feature values, the feature processing component 104 can implement aggregation logic to generate the stateful feature based on the aggregated feature data (or values). Once generated, the stateful feature can be encapsulated within a vector, tensor, or the like.

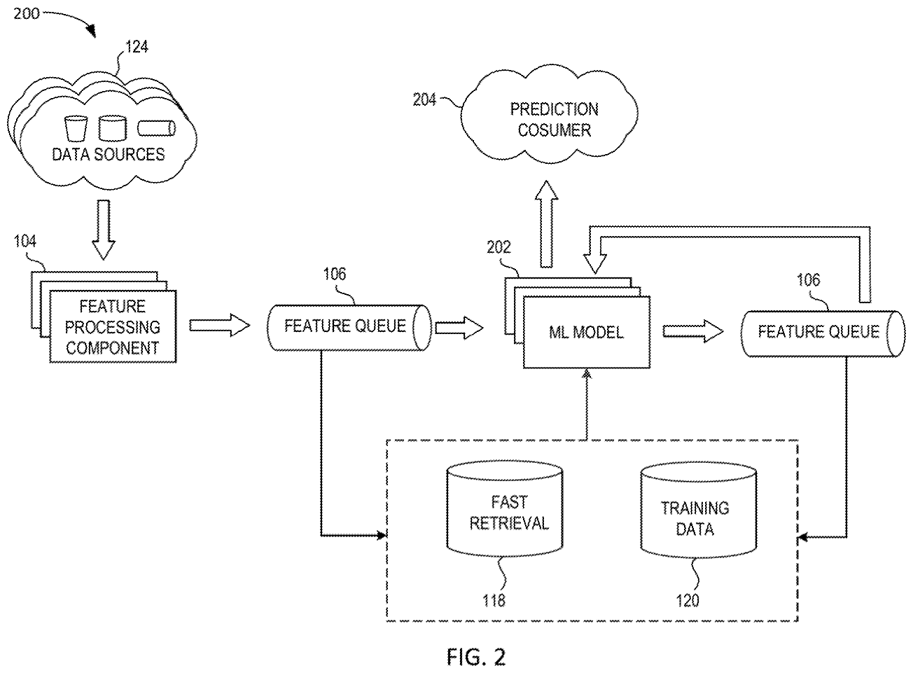

The feature queue 106 of the feature management platform 102 may comprise a write path to a multi-storage persistent layer of the feature management platform 102 (e.g., a fast retrieval database 118, a training data database 120, or other type of database). Once feature vectors are generated by the feature processing component 104, the feature vectors can be published on the feature queue 106 to provide to computing device(s) and/or models (as described in FIG. 2).

Additionally, the feature queue 106 is a queue that can protect the multi-storage persistent layer of the feature management platform 102 from “bad” code as a security measure to prevent data corruption. The feature queue 106 can act as an intermediary that can provide isolation of components in the feature management platform 102 that face the computing device by decoupling and abstracting featurization code (e.g., code fragment in the processing artifact) from storage. Further, the abstraction of the feature queue 106 is for both streaming and batch mode operations of the feature management platform 102.

Additionally, the feature queue 106 can include feature spaces, which can be “spaces” between published vector data. For example, the feature queue 106 can separate feature messages (e.g., vector messages) into groups or subsets prior to publishing. The feature queue 106 can separate each pipeline of feature processing from a computing device (e.g., to monitor and create alerts for feature(s)). In doing so, the feature queue 106 can allow for use case isolation and multi-tenancy support on the feature management platform 102.

For example, as more than one computing device 128 and/or model can connect to the feature management platform 102, the feature queue 106 can provide separation for the result of each processing job for each computing device 128 and/or model. The feature queue 106 can provide feature parity for all data points across all storage options and a single monitoring point for data quality, drift, and anomalies as well as pipeline integrity.

The internal state 108 is a shared component of the feature management platform 102. In some cases, the internal state 108 is a service and/or database that stores information regarding the state of all applications and/or components running on the feature management platform 102. For example, data stored in the internal state can include offsets, data markers, data processing and/or privacy regulations (e.g., California Consumer Privacy Act (CCPA)). The internal state 108 also includes a copy of feature metadata (or meta information) from the feature registry 112 and specific configuration items that assist in the operation of the feature management platform 102. Such storage of feature metadata and specific configuration items within the internal state 108 can be retrieved from and pushed to by the feature processing component 104 of the feature management platform 102 without any user intervention. For example, a copy of configuration information can be retrieved from the configuration file and synced to the feature registry, which can provide a user interface (e.g., via the API) to a computing device 128 for querying information regarding features.

The workflow scheduler 110 can schedule when feature processing jobs (e.g., a processing job, a feature logic calculation, an aggregation operation, etc.) can run in the feature management platform 102. In some cases, the workflow scheduler 110 can be a tool, data manager, or service capable of executing processing jobs. For example, a workflow scheduler 110 can be based on Jenkins, APACHE AIRFLOW™, ARGO EVENTS™, or other similar tool, manager, or service capable of scheduling the workflow of processing jobs.

The feature registry 112 component is a central registry of the feature management platform 102. The feature processing component 104 of the feature management platform 102 can parse configuration files received from computing devices 128 and register in the feature registry 112 the features generated (as described in the configuration file) by the feature processing component 104, including stateful features and stateless features. The features registered in the feature registry 112 are discoverable (e.g., based on metadata) and can be consumed by other use cases (e.g., by other computing devices requesting the feature for locally hosted models). For example, to discover a feature, the feature registry 112 can provide a user interface via the API of the feature management platform 102.

In some embodiments, the feature registry 112 is a feature metastore that can leverage a metadata framework for storing and managing feature data. For example, the feature registry 112 can leverage APACHE ATLAS™ for feature data storage and management. The feature registry 112 can be queried to discover feature computations for reuse that have been previously implemented and registered to the feature metastore.

Further, the feature management platform 102 may be configured to comply with self-service data governance and compliance regulations (e.g., privacy laws) by registering feature data in the feature registry 112 and requiring specific key columns in feature datasets that contain user identifiable data. In some cases, a connected cascade of indexing and delete jobs in compliance with governance and compliance regulations can be triggered automatically (e.g., without user involvement) by the feature management platform 102 to manage the feature data in the feature registry 112 and attached storage layers (e.g., delete data from the fast retrieval database 118, training data database 120, and aggregated state 116).

The compliance service 114 is a component of the feature management platform 102 that is an automated workflow that ensures data is processed according to compliance regulations. For example, the compliance service 114 can monitor and ensure that data is deleted in accordance with privacy laws (e.g., CCPA). The compliance service 114 can generate an audit of data processing for the feature management platform 102. For example, the compliance service 114 can create reverse indices on a given schedule and leverage the reverse index when performing delete requests and confirming deletion of data. In some cases, the feature management platform 102 can generate a status report of the deleted jobs.

In the instance of deleting data from a feature management platform 102, the delete job can be defined in a workflow and orchestrated by a data manager of the compliance service 114. For example, a computing device 128 can provide a request (e.g., on behalf of a user, entity, organization, etc.) to delete data in accordance with a law or regulation, such as the CCPA. Such request can be received via an API and stored in the internal state 108. Upon reaching the scheduled time for deleting data according to the request, the compliance service 114 can determine all identifiable data per the request and delete the data from data store(s). In some cases, the workflow of the delete job can be defined by services capable of organizing and cleaning data (e.g., AWS GLUE™, KUBERNETES™, etc.).

An aggregated state 116 of the feature management platform 102 includes a collection of feature data based on user-defined functions (e.g., feature calculation logic, aggregation logic, etc.). In this example, the aggregated state 116 is a distributed cache, external to feature processing component 104, which allows the feature management platform 102 to retain data state as aggregated feature data over a period of time (e.g., a number of distinct users per historic IP, a number of logins in a certain time period, etc.). In some cases, the aggregated state 116 can include all interim feature values that support a calculation of an aggregate function. In other cases, the aggregated state 116 can create and hold aggregated values over time per user per feature in order to provide model scorings (e.g., model scorings from AI/ML, models).

In some cases, the aggregated state 116 can be reused for multiple features, which adds to the reusable capability of the feature management platform 102. For example, the stateful feature generated based on data from the aggregated state 116, as well as the data in the aggregated state 116, can be requested by and provided to other computing devices without having to expend additional resources. The stateful feature can be stored in the fast retrieval database 118 and/or the training data database 120, and upon receiving a request for the stateful feature, the feature management platform 102 can provide the requested stateful feature without having to regenerate the feature.

Further, the aggregated state 116 is isolated, which makes such cache independent of application errors and failures as well as infrastructure changes to the feature management platform 102. Also, the implementation of the aggregated state 116 by the feature management platform 102 can result in sub millisecond latency of featurization transaction, which can enable close to real time prediction for AI/ML models that receive the stateful feature (as well as other feature data stateless feature(s)). In some cases, the aggregated state 116 can endure a throughput of 200% more (e.g., 650,000 TPS or more) for a single use case.

The fast retrieval database 118 (e.g., an online data store) and the training data database 120 (e.g., an offline data store) are each a type of feature store and represents a dual storage system for the feature management platform 102 in a persistent layer. As part of the dual storage system, persistent data 126 is stored within the fast retrieval database 118 and training data database 120. The persistent data 126 in the persistent layer (e.g., either the fast retrieval database 118 or the training data database 120) may comprise feature values and/or predictions that are stored for model use cases or training.

For example, the fast retrieval database 118 can include recently generated feature data and/or predictions that can be provided to a model hosted locally on a computing device to generate real-time predictions (e.g., for model use cases and/or inferences). The fast retrieval database 118 can store the most recent (or latest) feature data and/or predictions at a low latency. The training data database 120 can include feature data and/or predictions that can be provided to train a model hosted locally on a computing device (e.g., for model training). The training data database 120 can include all of the generated feature data, including previously generated feature data.

In one example, the feature management platform 102 can generate a stateful feature regarding the number of distinct IP addresses up to a given point in time for each user name. To train a supervised machine learning model on a computing device that can generate a label for user name n at some point in time tin the past, the value of the count distinct feature for the user name n at time t can be retrieved from the feature management platform 102. In particular, the training data database 120 can include for each feature and entity, an ordered set of timestamped feature values. Such data is transmitted to the computing device 128 to train the supervised machine learning model. For a prediction or real-time inference, regarding the most recent (or up-to-date) feature value of the IP address for a user name, then such data can be retrieved from the fast retrieval database 118, which includes the latest feature values.

In some cases, the dual storage system can include a scalable database, such as a DYNAMODB™. The persistent layer of the dual storage system can serve recent feature values at low latency. In some cases, the feature values are grouped and/or compressed (e.g., by using protocol buffers, or Protobuf, to serialize structured data). Additionally, the dual storage system of the fast retrieval database 118 and the training data database 120 includes “smart updates” that prevent older feature values from being overwritten by new feature values during feature revisions (e.g., that are generated by the feature processing component 104). In some cases, the feature management platform 102 can include other types of data storage, such as a persistent database, for storing persistent data such as timestamp data.

The metric data 122 is generated by transformation of the event data that is related to the pipeline or processing job execution. The metric data 122 can be used to monitor the performance of processing jobs and to understand operation metrics. In some cases, the metric data 122 can be monitored via a monitoring platform (e.g., WAVEFRONT™ by VMWare). In other cases, the metric data 122 can be used to create alerts for the feature management platform 102.

### Example Diagram of the Feature Management Platform Interacting with Models

FIG. 2 depicts an example diagram 200 of a feature management platform's interactions with model(s), such as models in an ensemble of machine learning models.

The feature processing component 104 generates feature data based on event data from data sources 124, as described in FIGS. 1 and 3. Upon generating the feature data, the feature processing component 104 of the feature management platform publishes the feature data on the feature queue 106. In some cases, the feature data is published in a vector representation, tensor representation, and other similar types of format representations capable of storing feature data. In other cases, the feature queue 106 of the feature management queue can consume predictions generated by machine learning models 202 and transmitted to the feature management platform. The predictions consumed by the feature queue 106 can be in a vector representation, tensor representation, and other similar types of format representations capable of storing the prediction as feature data on the feature queue 106.

Based on the data structure of the feature queue 106, the feature data and/or predictions can be stored on a channel in the feature queue 106. The feature queue 106 can include a protocol for serializing data in the data structure of the feature queue 106 (e.g., protocol buffers). In some cases, the feature queue 106 can publish feature data and consume predictions in a streaming and/or batch mode. The feature queue 106 can include a plurality of channels that can allow for multi-tenancy and shareability on the feature management platform of feature data and/or predictions. The feature data and/or predictions can be stored in a namespace on a channel and be accessible to other machine learning models 202. For example, each channel of a feature queue 106 can include its own set of encryption and permissions for controlling access to the feature data and/or prediction data stored within the channel. Further, the machine learning models 202 can subscribe to one or more channels of the feature queue 106. By subscribing to the feature queue 106, the machine learning models 202 can monitor the feature queue 106 channel(s) to determine when newly generated feature data and/or predictions are available for input to the machine learning models 202. The data structure of the feature queue 106 can allow for a single write (e.g., feature data and/or prediction to a channel) and multi-query (e.g., multiple machine learning models can implement the feature data stored in a channel to generate a prediction).

Further, based on the data structure and standardized format, the feature queue 106 can be a singular and unified interface between the machine learning model(s) 202 and feature management platform. For example, the feature queue 106 can ensure multiplexing of feature data and/or predictions to different storage layers (e.g., fast retrieval database 118 and training data database 120). In some cases, the feature data and/or predictions recently generated can be stored in the fast retrieval database 118 and be provided to machine learning models 202 for generating predictions based on the latest data available. In other cases, the feature data and/or predictions can be stored in the training data database 120 and be provided for training machine learning models 202. The data structure and standardized format of the feature queue 106 can result in the shareability of features and/or predictions via the feature management platform. The feature queue 106 can also be configured to tolerate a variable range of downtime of the feature management platform, which can make bug fixes and system upgrades for the feature management platform easier. During the downtime of the feature management platform, machine learning models 202 can still access feature data stored in the feature queue 106, as well as the fast retrieval database 118 or training data database 120.

In one embodiment, the feature management platform can be configured to implement an ensemble of machine learning models 202. For example, an organization can manage user interactions with each other and with resources associated with the organization. As such, the organization will want to confirm that the users are who they claim to be when interacting with the organization (e.g., other users or resources associated with the organization), provide assistance to users as needed, etc. In order to manage operation(s), the organization can establish an ensemble (or a set) of machine learning models 202 to monitor activities and interactions. Ensemble machine learning models can work together to generate an accurate and timely prediction, which an organization can use for fraud detection, user support, service and/or product abandonment, etc.

In some cases, a computing device associated with the organization can provide a configuration file and/or code fragment data to the feature management platform. In doing so, the computing device can retrieve training data to generate an ensemble of machine learning models that can generate predictions associated with the operation(s) of the organization. For example, the ensemble of machine learning models can be trained to alert the organization that a fraudulent user is attempting to access resources.

In other cases, if the machine learning models 202 have been previously trained and are accessible by the organization via the feature management platform, then the computing device associated with the organization can indicate (e.g., via an API), which prediction is sought or which feature data to input to machine learning models to generate a new prediction.

In the instance that an ensemble of machine learning models 202 is trained, the feature management platform can transmit the available feature data and/or predictions that are recently generated (e.g., generated within a predetermined period of time) to the corresponding subscribing machine learning model(s) 202. The feature management platform can transmit the feature data and/or predictions (e.g., that are saved as feature data) upon availability in a feature queue 106, such as when the feature data is stored in a channel of the feature queue 106 that the machine learning model 202 is subscribed to. For example, the machine learning models 202 of the ensemble may not all be implemented at the same time because not all of the feature data and/or prediction data may be available to transmit or may be outdated. In such cases, a set of machine learning models 202 from the ensemble may be implemented first based on transmission of recently generated feature data and/or prediction from the feature queue 106 to subscribing machine learning models 202.

Once the machine learning models 202 in the first group generate predictions and transmit the predictions back to the feature queue 106, the feature management platform can provide the prediction(s) as well as any newly generated feature data as feature input(s) to the remaining machine learning models 202 in the ensemble. In some cases, the feature management platform can provide the input data at different times (e.g., in more than one group) to the remaining machine learning models 202 in the ensemble based on when feature data becomes available. The feature management platform can continue to provide newly generated feature data and/or predictions to the first group of models 202, in order to provide up-to-date feature data and/or predictions that the other machine learning models 202 of the ensemble can use to generate predictions.

After each machine learning model 202 of the ensemble is implemented by the feature management platform transmitting input data, the generated prediction (e.g., based on inputting one or more predictions generated by machine learning models 202 of the ensemble to other machine learning model(s) 202 of the ensemble) can be provided to the prediction consumer 204.

In some cases, the prediction consumer 204 can be a computing device associated with the organization. For example, if the ensemble of machine learning models 202 generates a prediction that a user is fraudulently attempting to access a resource, the feature management platform can provide an alert to the computing device based on the prediction. In doing so, the organization can act accordingly to prevent the fraudulent user from access the resource.

In another example, the ensemble of machine learning models 202 that subscribe to the feature queue 106 for available input data can generate predictions regarding operational decisions for a prediction consumer 204 (e.g., organization). For example, the ensemble of machine learning models 202 can generate a prediction (e.g., based one or more predictions generated by the ensemble and input to machine learning model(s) within the ensemble to generate the prediction) of determining user support to provide to a user, abandonment of a product and/or service, etc.

### Example Pipeline of the Feature Management Platform

FIG. 3 depicts an example diagram 300 of a pipeline 302 of the feature management platform. In some embodiments, the example pipeline 302 is part of the feature processing component of the feature management platform as described in FIG. 1. The feature management platform includes a platform API for users to interact with the feature management platform. In some cases, the API is built on top of APACHE SPARK′ and can support Scala, SQL, and Python as interface languages.

The API of the feature management platform is an entry point for a computing device (e.g., via user interface(s)) and is responsible for the generation and execution of processing jobs via a pipeline 302. In some cases, the API defining the pipeline 302 can operate in either structured streaming or in batch mode. For example, the pipeline 302 can process event data from a streaming data source or a batch data source. The same API is offered to each computing device (e.g., via user interface(s)) and can backfill features. The API defines the pipeline 302 and includes a data source 304, preprocessor(s) 306, a feature calculation module 308, a featurizer 310, and a feature sink 312. In some cases, a user interface is provided by the API for each aspect of the pipeline 302 to define the feature (e.g., data source 304, preprocessor(s) 306, a feature calculation module 308, a featurizer 310, and a feature sink 312). The API can be agnostic and implemented on different types of databases.

For example, the feature management platform can receive a processing artifact (e.g., a configuration file and/or code fragment). Based on the processing artifact received, the API of the feature management platform can define the pipeline 302 along with input received via the user interface(s) provided by the API to the computing device(s) for generating a feature from event data. In some cases, the data source 304 (e.g., defined in the configuration file) retrieves event data for feature processing by the pipeline 302.

In some cases, the data source 304 as defined (e.g., in the configuration file) for the feature can include a batch data source and/or a streaming data source from which to retrieve data from to generate feature data. In such cases, the API of the feature management platform can generate a batch processing job and/or a real-time processing job. The batch processing job can be initiated by the pipeline 302 to generate feature data for a defined period of time, up to the present time. Upon reaching the present time, the batch processing job can be completed. In some cases, where the data source defined includes both a batch and streaming data source, once the batch processing job is completed, then the real-time processing job can be initiated. For example, the pipeline 302 can retrieve event data from a batch data source for the batch processing job and can retrieve event data from the streaming data source for the real-time processing job once the batch processing job is completed.

The data source 304 can include HIVE™, EBUS™, S3™, or other data sources capable of storing data. The preprocessor(s) 306 can be chained together or sequentially executed to filter out event data. For example, if click stream data regarding the “clicks” on a web page, link, etc., was retrieved from the data source 304, then the preprocessor(s) 306 can filter out (or remove) test data from the click stream data prior to calculation by the feature calculation module 308.

The feature calculation module 308 can perform operations (e.g., as defined by a user interface and/or configuration file). For example, the feature calculation module 308 can perform feature logic calculations and aggregation operations (e.g., a count, average, and other types of operation on event data and/or feature data). The feature calculation module 308 can implement the aggregation operation(s) as defined by the processing artifact to generate a stateful feature.

In some cases, the feature calculation module 308 can perform the calculation of event data in parallel in the pipeline 302. The feature calculation module 308 can generate a table of results, and the featurizer 310 can transform the table into a feature vector format. The featurizer 310, upon generating the feature vector by transforming the table results of the feature calculation module 308, can then push the feature vector to the feature sink 312. In some cases, the feature sink 312 can be a feature queue of the feature management platform (e.g., a feature queue 106 as described in FIG. 1) that publishes the feature vector for a computing device.

### Example Method of Feature Management Platform Interactions

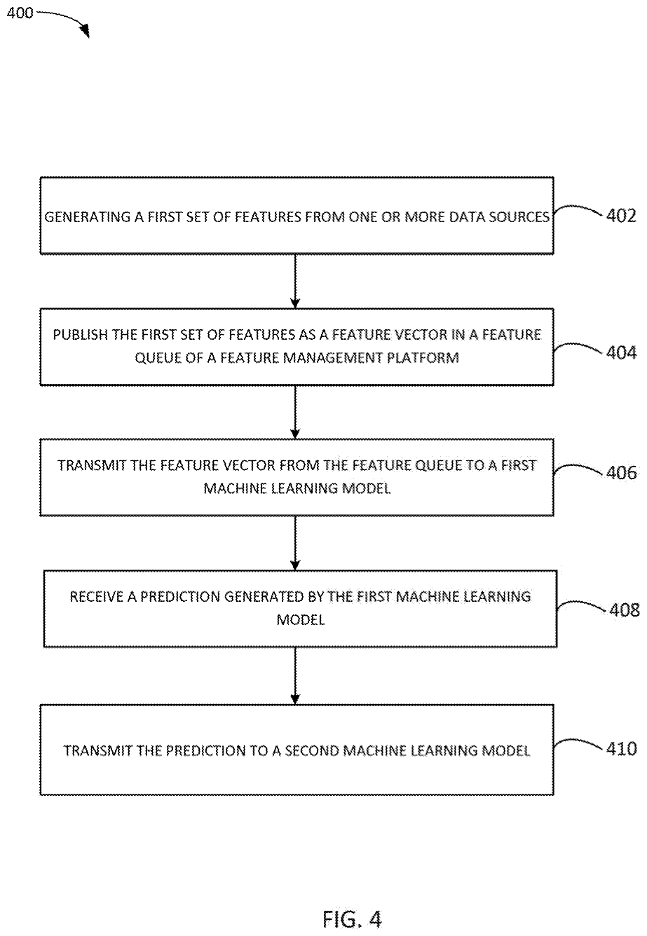

FIG. 4 depicts an example flow diagram 400 of a method of feature management platform interactions, as described with respect to FIGS. 1-3.

At 402, a feature management platform generates a first set of features from one or more data sources, such as described in FIGS. 1 and 3.

At 404, the feature management platform publishes the first set of features as a feature vector in a feature queue of a feature management platform. In some cases, the first set of features may be published in the feature queue in tensor format. The first set of features can be published in a channel of the feature queue that has one or more subscribers (e.g., models or computing devices).

At 406, the feature management platform transmits the feature vector from the feature queue to a first machine learning model. The first machine learning model can be a subscriber to the feature queue of the feature management platform. As a subscriber to the feature queue, the first machine learning model can monitor (e.g., via an associated monitoring service) the feature queue for new feature(s) and/or prediction(s) that are applicable as input(s) to generate a prediction.

When the feature data published at 404 is stored in the feature queue, the respective subscribing machine learning model(s) can receive the feature data in 406. For example, upon storing the feature data in the feature queue, the feature management platform can automatically transmit the feature data to all subscribing machine learning models. In another example, a machine learning model that is monitoring the feature queue can receive an alert that feature data is available for retrieval (e.g., via the host computing device). Once the machine learning model receives the feature data, the feature data is input and the machine learning model is automatically executed to generate a prediction.

At 408, the feature management platform receives a prediction generated by the first machine learning model. In some cases, the feature management platform receives the prediction in the same representational format as the feature transmitted to the first machine learning model. For example, if the feature management platform transmits a feature as a feature vector, the prediction received from the first machine learning model is also in a vector format. In some cases, the vector can represent a single element or more than one element. Upon receiving the prediction, the feature management platform can store the prediction as feature data in the feature queue, such that other machine learning models can use the feature data (e.g., the prediction) as input to generate a new prediction, for example, as described in 410.

At 410, the feature management platform transmits the prediction to a second machine learning model. In some cases, the prediction is stored as feature data in the feature queue. The second machine learning model can be a subscriber to the feature queue (e.g., to a different channel than the first machine learning model) that can depend on the prediction generated by the first machine learning model as input to generate a prediction. In some cases, the second machine learning model can be implemented on the same computing device as the first machine learning model. In other cases, the second machine learning model can be implemented on a different computing device.

In some cases, the first machine learning model and the second machine learning model are part of an ensemble of machine learning models, where the output generated by some machine learning model(s) of the ensemble are the input to other machine learning model(s). In such cases, the feature management platform transmits the feature data to a first set of machine learning models of the ensemble that includes the first machine learning model based on available feature data stored in the queue and subscription of machine learning models to the channel the feature data is stored on.

The feature management platform may not transmit feature data to all of the models of the ensemble at the same time, but rather asynchronously. This is because based on the subscription of each machine learning model in the ensemble to the feature queue, the feature data may be available as input (e.g., stored in a channel) for some subscribing machine learning models but not all. For example, the feature data can be recently generated or prediction data recently received by the feature management platform (e.g., within a pre-defined period of time). The machine learning models that subscribe (and/or monitor) the feature queue channel(s) for such data can receive the generated data to execute the machine learning model for generating a prediction when the input data is available in the feature queue channel(s).

With the available input data, the first set of machine learning models can generate predictions to provide to the feature management platform. As the first set of machine learning models generate the predictions, the feature management platform continues to generate feature data. In doing so, the feature management platform can continue to provide recently generated feature data and/or prediction to other models of the ensemble at different times (and in more than one set). Based on the dependencies of the machine learning models in the ensemble, the ensemble of machine learning models can generate a prediction for the organization (e.g., fraud detection, user support, product and/or service abandonment, etc.).

### Example Method of a Model Interacting with a Feature Management Platform

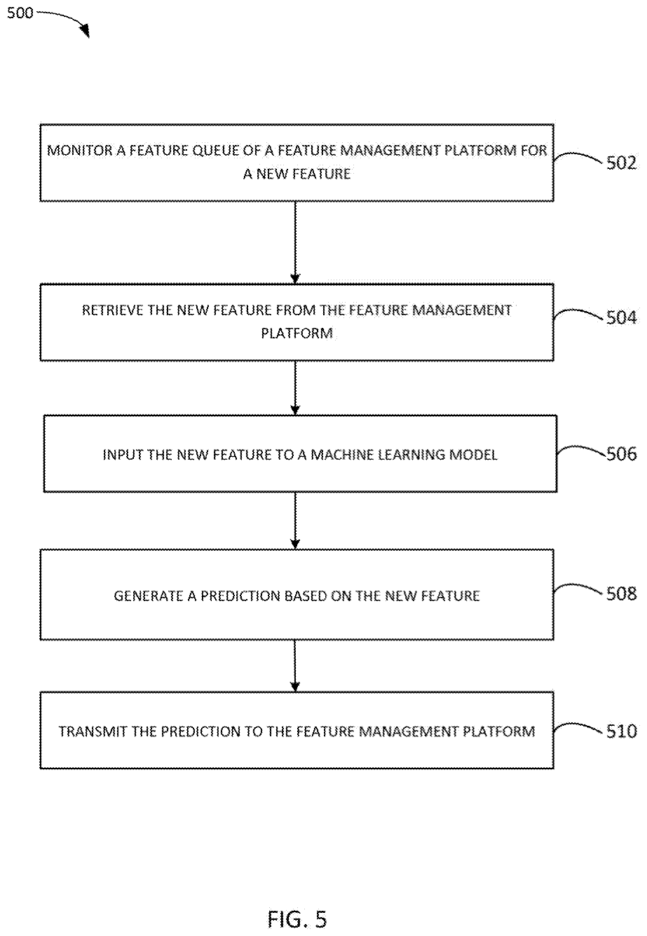

FIG. 5 depicts an example flow diagram 500 of a method of a model interacting with a feature management platform, as described with respect to FIG. 1. The model can be implemented on a computing device that can connect to the feature management platform.

At 502, a model monitors a feature queue of a feature management platform for a new feature. In some cases, the model can be a subscriber to one or more channels of the feature queue (e.g., via a subscription service). As such, when a new feature is published on the feature queue, the model can be alerted to the new feature. For example, the feature management platform can trigger an invocation or an alert when there is a new feature published in a channel of the feature queue that the model subscribes to.

At 504, the model retrieves the new feature from the feature management platform. In some cases, the retrieved feature is in a vector format representation (e.g., feature vector data). In other cases, the retrieved feature is in tensor format representation. The model can retrieve the new feature via a computing device that hosts the model. The model can retrieve more than one new feature (e.g., feature data and/or prediction) from the feature management platform.

At 506, the model inputs the feature as an input value to generate a prediction for a use case the model is trained to generate.

At step 508, the model generates a prediction based on the new feature. For example, the model can generate a prediction as part of a set of predictions generated by an ensemble of models. An organization can implement the ensemble of models to generate (e.g., based on the set of predictions) a prediction regarding operation of the organization, including the products and/or services provided by the organization. Operations of the organization can include fraud detection, customer support, product and/or service abandonment, etc.

At 510, the model transmits the prediction to the feature management platform. In some cases, the prediction is in the same format as the retrieved feature at 506 (e.g., vector, tensor, etc., format representation).

In some cases, the model can be part of an ensemble of machine learning models that can monitor the feature queue and retrieve a prediction generated by another model and/or feature data generated by the feature management platform. In such cases, the prediction and/or feature data generated by the other model is the input value to generate a new prediction to transmit to the feature management platform. Further, the prediction retrieved can be generated by a model implemented on the same or different computing device.

### Example Server

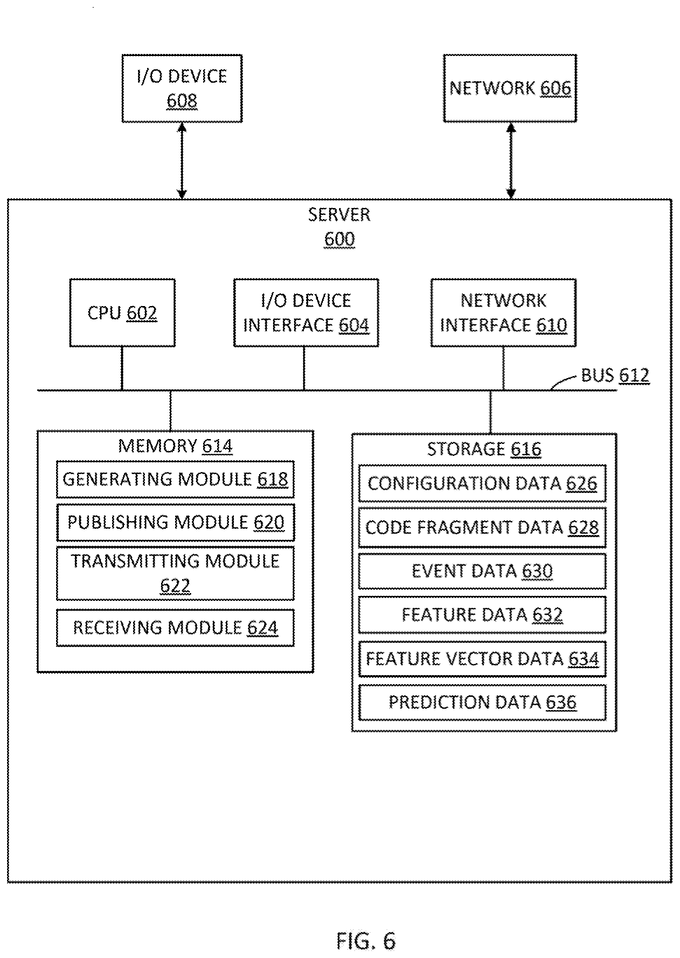

FIG. 6 depicts an example server 600 that may perform the methods described herein, for example, as described with respect to FIGS. 1-4. For example, the server 600 can be a physical server or a virtual (e.g., cloud) server and is not limited to a single server that performs the methods described herein, for example, with respect to FIGS. 1-4.

Server 600 includes a central processing unit (CPU) 602 connected to a data bus 612. CPU 602 is configured to process computer-executable instructions, e.g., stored in memory 614 or storage 616, and to cause the server 600 to perform methods described herein, for example with respect to FIGS. 1-4. CPU 602 is included to be representative of a single CPU, multiple CPUs, a single CPU having multiple processing cores, and other forms of processing architecture capable of executing computer-executable instructions.

Server 600 further includes input/output (I/O) device(s) 608 and interfaces 604, which allows server 600 to interface with input/output devices 608, such as, for example, keyboards, displays, mouse devices, pen input, and other devices that allow for interaction with server 600. Note that server 600 may connect with external I/O devices through physical and wireless connections (e.g., an external display device).

Server 600 further includes network interface 610, which provides server 600 with access to external network 606 and thereby external computing devices.

Server 600 further includes memory 614, which in this example includes a generating module 618, publishing module 620, a transmitting module 622, and a receiving module 624 for performing the operations as described in FIGS. 1-4.

Note that while shown as a single memory 614 in FIG. 6 for simplicity, the various aspects stored in memory 614 may be stored in different physical memories, but all accessible by CPU 602 via internal data connections such as bus 612.

Storage 616 further includes configuration data 626, which may include the configuration file, as described in FIGS. 1, 3.

Storage 616 further includes code fragment data 628, which may include code fragment data that is received by the feature management platform (e.g., with a configuration file), as described in FIGS. 1, 3.

Storage 616 further includes event data 630, which may include event data (or raw data) retrieved from data sources for determining feature data, as described in FIGS. 1-3.

Storage 616 further includes feature data 632, which may be like the feature data (or feature values) as generated by implementing feature logic calculations, feature metadata, stateful features, stateless features, etc., as described in FIGS. 1-4.

Storage 616 further includes feature vector data 634. Which may include vectors representing feature data 632, as described in FIGS. 1-4.

Storage 616 further includes prediction data 636, which may include prediction(s) received from machine learning model(s) located on computing device(s), as described in FIGS. 1-4.

While not depicted in FIG. 6, other aspects may be included in storage 616.

As with memory 614, a single storage 616 is depicted in FIG. 6 for simplicity, but various aspects stored in storage 616 may be stored in different physical storages, but all accessible to CPU 602 via internal data connections, such as bus 612, or external connections, such as network interfaces 604. One of skill in the art will appreciate that one or more elements of server 600 may be located remotely and accessed via a network 606.

### Example Computing Device

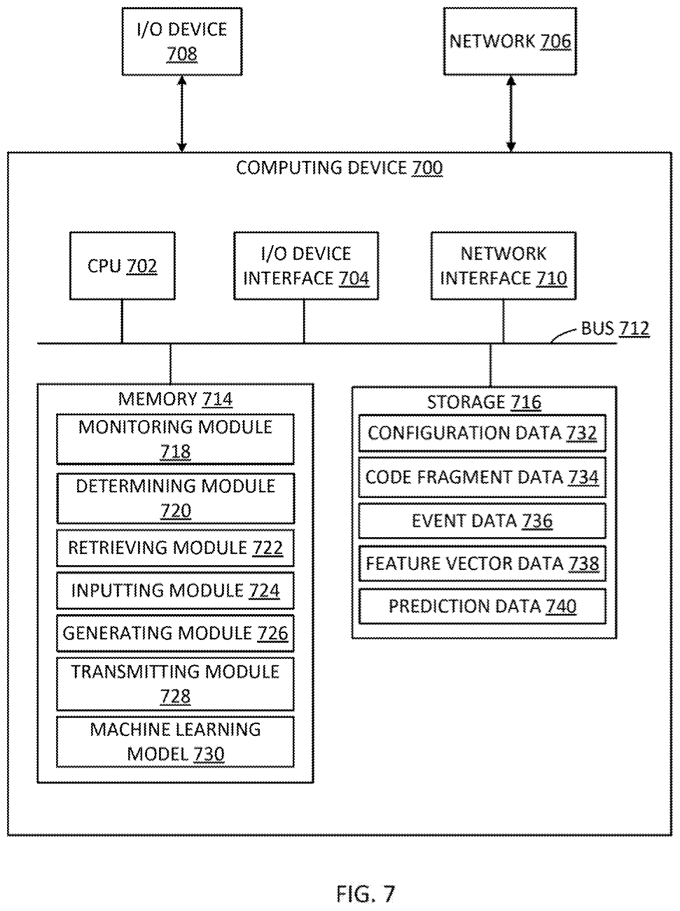

FIG. 7 depicts an example computing device 700 that may perform the methods described herein, for example, with respect to FIG. 5. For example, the computing device 700 can be a computer, laptop, tablet, smartphone, a virtual machine, container, server, or other computing device with the same or similar capabilities (e.g., that includes training and implementing models as well as serving predictions to applications running on such computing device). The methods described here, for example, with respect to FIG. 5 can be performed by one or more computing devices 700 connected to the feature management platform.

Computing device 700 includes a central processing unit (CPU) 702 connected to a data bus 712. CPU 702 is configured to process computer-executable instructions, e.g., stored in memory 714 or storage 716, and to cause the computing device 700 to perform methods described herein, for example with respect to FIG. 5. CPU 702 is included to be representative of a single CPU, multiple CPUs, a single CPU having multiple processing cores, and other forms of processing architecture capable of executing computer-executable instructions.

Computing device 700 further includes input/output (I/O) device(s) 708 and interfaces 704, which allows computing device 700 to interface with input/output devices 708, such as, for example, keyboards, displays, mouse devices, pen input, and other devices that allow for interaction with computing device 700. Note that computing device 700 may connect with external I/O devices through physical and wireless connections (e.g., an external display device).

Computing device 700 further includes network interface 710, which provides computing device 700 with access to external network 706 and thereby external computing devices.

Computing device 700 further includes memory 714, which in this example includes a monitoring module 718, a determining module 720, a retrieving module 722, an inputting module 724, a generating module 726, a transmitting module 728, and a machine learning model 730 for performing operations described, for example, in FIG. 5.

Note that while shown as a single memory 714 in FIG. 7 for simplicity, the various aspects stored in memory 714 may be stored in different physical memories, but all accessible by CPU 702 via internal data connections such as bus 712.

Storage 716 further includes configuration data 732, which may be like the configuration file, as described in FIGS. 1, 3.

Storage 716 further includes code fragment data 734, which may include code fragment data that is generated by the computing device and provided to the feature management platform, as described in FIGS. 1, 3.

Storage 716 further includes event data 736, which may include data regarding instances of interactions associated with the computing device 700 as described in FIG. 1. In some cases, the event data 736 can be provided to the feature management platform to generate feature data.

Storage 716 further includes feature vector data 738, which may include the vector representing a set of features, as described in FIGS. 1 and 5. In some cases, the feature vector data 738 can train a machine learning model or be input to a trained machine learning model to generate a prediction associated with a use case.

Storage 716 further includes prediction data 740, which may include prediction(s) generated by a computing device that locally implemented a model with feature vector data 738 received from the feature management platform, as described in FIGS. 1 and 5.

While not depicted in FIG. 7, other aspects may be included in storage 716.

As with memory 714, a single storage 716 is depicted in FIG. 7 for simplicity, but various aspects stored in storage 716 may be stored in different physical storages, but all accessible to CPU 702 via internal data connections, such as bus 712, or external connections, such as network interfaces 704. One of skill in the art will appreciate that one or more elements of computing device 700 may be located remotely and accessed via a network 706.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
generating a first set of features from one or more data sources;
publishing the first set of features as a feature vector in a feature queue of a feature management platform;
transmitting the feature vector from the feature queue to a first machine learning model;
receiving a prediction generated by the first machine learning model; and
transmitting the prediction to a second machine learning model.

2. The method of claim 1, wherein publishing the first set of features in the feature queue triggers an invocation of the first machine learning model.

3. The method of claim 1, wherein the prediction is received from the first machine learning model and transmitted to the second machine learning model by the feature queue.

4. The method of claim 1, wherein the received prediction is in a vector format.

5. The method of claim 1, further comprising: publishing the prediction to the feature queue as a second feature.

6. The method of claim 5, wherein the prediction is a feature input for the second machine learning model.

7. The method of claim 1, wherein each feature vector published on the feature queue is stored in a persistent layer of the feature management platform.

8. The method of claim 7, further comprising:
retrieving a third feature from the persistent layer via the feature queue; and
transmitting the third feature to the second machine learning model.

9. The method of claim 7, wherein the feature queue of the feature management platform is monitored by one or more machine learning models that subscribe to the feature queue for new feature data.

10. A system, comprising:
a processor; and
a memory storing instructions, which when executed by the processor perform a method comprising:
generating a first set of features from one or more data sources;
publishing the first set of features as a feature vector in a feature queue of a feature management platform;
transmitting the feature vector from the feature queue to a first machine learning model;
receiving a prediction generated by the first machine learning model; and
transmitting the prediction to a second machine learning model.

11. The system of claim 10, wherein the method further comprises publishing the first set of features in the feature queue triggers an invocation of the first machine learning model.

12. The system of claim 10, wherein the prediction is received from the first machine learning model and transmitted to the second machine learning model by the feature queue.

13. The system of claim 10, wherein the received prediction is in a vector format.

14. The system of claim 10, wherein the method further comprises: publishing the prediction to the feature queue as a second feature.

15. The system of claim 14, wherein the prediction is a feature input for the second machine learning model.

16. The system of claim 10, wherein each feature vector published on the feature queue is stored in a persistent layer of the feature management platform.

17. The system of claim 16, wherein the method further comprises:
retrieving a third feature from the persistent layer via the feature queue; and
transmitting the third feature to the second machine learning model.

18. The system of claim 16, wherein the feature queue of the feature management platform is monitored by one or more machine learning models that subscribe to the feature queue for new feature data.

19. A method, comprising:
monitoring a feature queue of a feature management platform for a new feature;
retrieving the new feature from the feature management platform;
inputting the new feature to a machine learning model;
generating a prediction based on the new feature; and
transmitting the prediction to the feature management platform.

20. The method of claim 19, wherein the machine learning model retrieves based on a subscription service more than one new feature from the feature management platform to generate the prediction.
